(19) United States
(12) Patent Application Publication
(10) Pub. No.: US 2025/0334144 A1
(43) Pub. Date: Oct. 30, 2025

(54) DOUBLE ENDED HOOK WITH DUAL LOCKS

(71) Applicant: Zhenfeng Xu, Yangjiang City (CN)

(72) Inventor: Zhenfeng Xu, Yangjiang City (CN)

(21) Appl. No.: 18/818,244

(22) Filed: Aug. 28, 2024

(30) Foreign Application Priority Data
Apr. 30, 2024 (CN) 202420943850.4

(51) Int. Cl. F16B 45/02

(52) U.S. Cl. CPC F16B 45/023; F16B 45/024; F16B 2200/83

(57) ABSTRACT

The present invention discloses a double ended hook with dual locks, relating to the technical field of hooks, comprising a hook frame having locking member, the bottom end of hook frame is fixedly connected with a magnetic block, one side of hook frame is fixedly connected with reinforcement locking member to connect with another hook frame, the reinforcement lock member comprises a first locking buckle, one end of first locking buckle is rotatably connected with one side of hook frame, and the other side of hook frame is fixedly connected with first limiting member. The invention further fixes two hook frames under magnetic adsorption through the reinforcement lock member, so even when the double ended hook loads a weight exceeding the adsorption force between magnetic blocks, the reinforcing lock member that can be simply operated bears the load capacity between two hook frames, minimizing their separation and improving the convenience.

### REFERENCE TO PRIOR APPLICATION

This application claims priority to Chinese Patent Application 202420943850.4, filed on Apr. 30, 2024, which is incorporated herein by reference.

### TECHNICAL FIELD

The present invention relates to the field of hook technology, specifically a double ended hook with dual locks.

### BACKGROUND

The two ends of the double ended hook comprise of hooks, with one end fixed in a fixed position and the other end used for hanging items.

The double ended hook is fixed between two hooks through magnetic force, but the magnetic buckle has limited load-bearing capacity and can only hang small weight items, making it difficult for users to determine the actual weight of the items, and the likely separation of the double ended hooks during use affects the effectiveness of the double ended hook. Therefore, a double ended hook with dual locks is proposed.

### SUMMARY OF INVENTION

The purpose of the present invention is to provide a double ended hook with dual locks to address the problems raised in the background art mentioned above.

To achieve the above objectives, the present invention provides the following technical solution: a double ended hook with dual locks comprises a hook frame, wherein the hook frame is provided with a locking member, the bottom end of the hook frame is fixedly connected with a magnetic block, one side of the hook frame is fixedly connected with a reinforcement lock member for connecting with another hook frame, the reinforcement lock member comprises a first locking buckle, one end of the first locking buckle is rotatably connected with one side of the hook frame, the other side of the hook frame is fixedly connected with a first limiting member, and the bottom end of the first limiting member is provided with a first limiting groove.

Preferably, the reinforcement lock member further comprises a rotating member, one end of the rotating member is rotatably connected to one side of the hook frame, the inner wall of the rotating member is rotatably connected to a second locking buckle, and one side of the other hook frame is fixedly connected to a second limiting member, and the top of the second limiting member is provided with a second limiting groove.

Preferably, the reinforcement lock member further comprises a half disk fixedly installed on one side of the hook frame, and the outer wall of the half disk is slidably connected with a circular ring, and a restriction member that restricts the movement of circular ring is installed on the half disk.

Preferably, the limiting member comprises a micro spring fixedly installed inside the half disk, one end of the micro spring is fixedly connected to the third limiting member, and a limiting groove is provided inside the circular ring for contacting the third limiting member, and the outer wall of the third limiting member is slidably connected to the interior of the half disk.

Preferably, the interior of the half disk is provided with a sliding groove, and the outer wall of the third limiting member is slidably connected to the interior of the half disk through the sliding groove.

Preferably, the locking member comprises a limiting rotating rod, the bottom end of the limiting rotating rod is rotatably connected to the hook frame, and a torsion spring is fixedly connected at the rotational connection between the limiting rotating rod and the hook frame.

Compared with the prior art, the present invention has the following the beneficial effects:

The double ended hook with dual locks can further fix the position between two hook frames under magnetic adsorption through the reinforcement lock member, so that even when the double ended hook is loading a weight exceeding the adsorption force between the magnetic blocks, the reinforcing lock member will bear the load capacity between the two hook frames, thereby minimizing the separation of double ended hooks during use, and the simple operation of the reinforcing lock member improves the convenience of the double ended hook.

In further the deployment of limiting member can further restrict the movement of circular ring during use, so that the circular ring is fixed in the set position and during use, the load-bearing force acts on the magnetic block and the circular ring, while the limiting member is not subjected to external forces, thus ensuring the limitation of the circular ring, and this design improves the practicality of limiting member and the reliability of the double ended hook.

### BRIEF DESCRIPTION OF THE DRAWINGS

FIG. 1 is an isometric view of the present invention;

FIG. 2 is an isometric view of Embodiment 1 of the present invention;

FIG. 3 is an isometric view of Embodiment 2 of the present invention;

FIG. 4 is an isometric view of Embodiment 3 of the present invention;

FIG. 5 is a cross-sectional view of the limiting component of the present invention.

Where: 1. Hook frame; 2. Locking member; 201. Limiting rotating rod; 3. Reinforcement lock member; 301. First lock buckle; 302. Second restriction component; 303. rotating members; 304, second lock buckle; 305. Second limiting member; 306. Half disk; 307. Circular ring; 308. Micro spring; 309. Third limiting member; 4. Magnetic block.

### DETAILED DESCRIPTION OF THE EMBODIMENTS

The technical solutions in the embodiments of the present invention will be clearly and completely described below in conjunction with the accompanying drawings. Obviously, the described embodiments are only a part of, other than all of, the embodiments thereof. Based on the embodiments of the present invention, all other embodiments obtained without creative labor by the persons having ordinary skill in the art are within the scope of protection of the present invention.

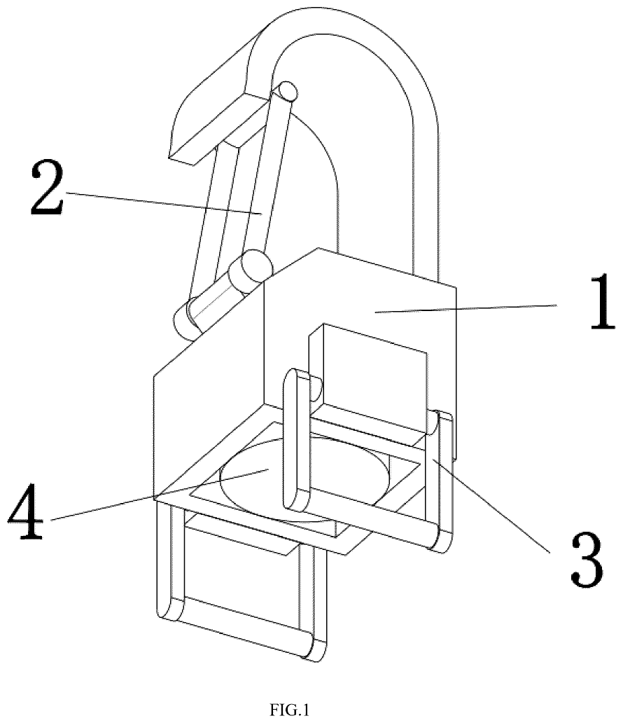

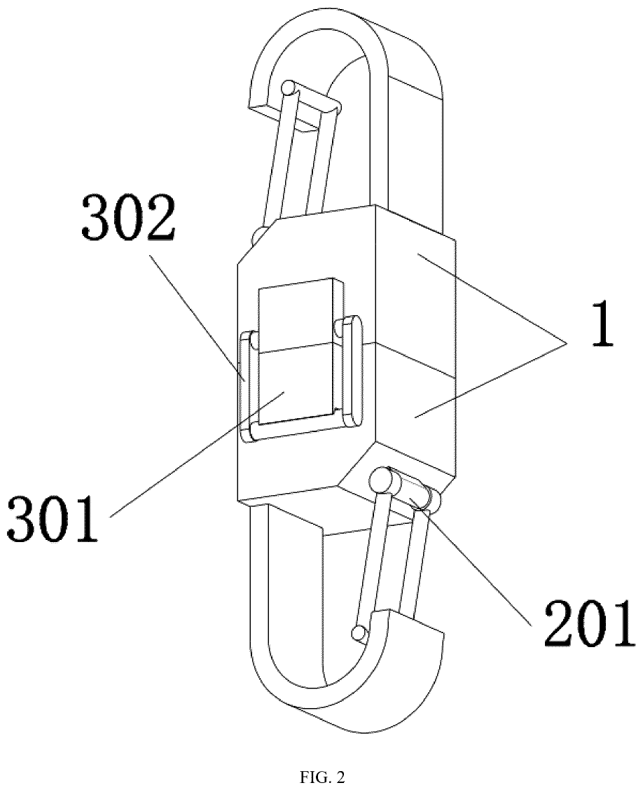

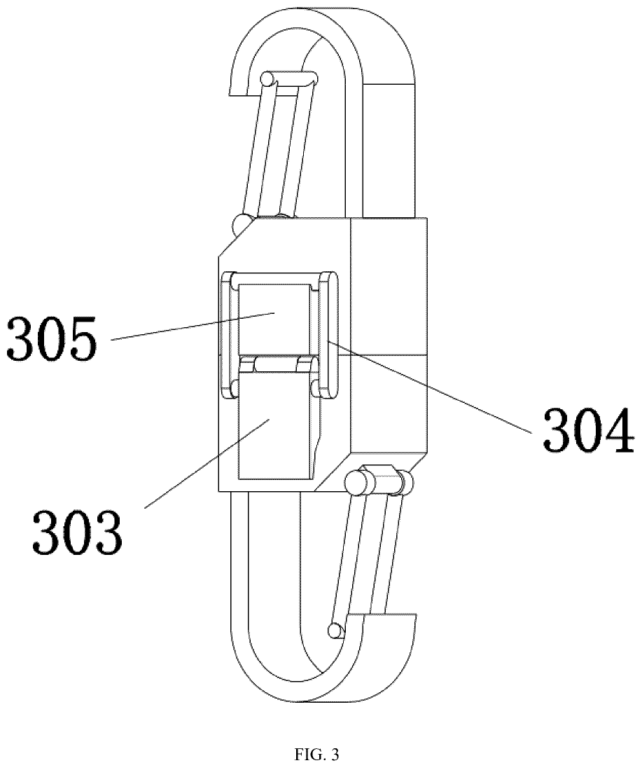

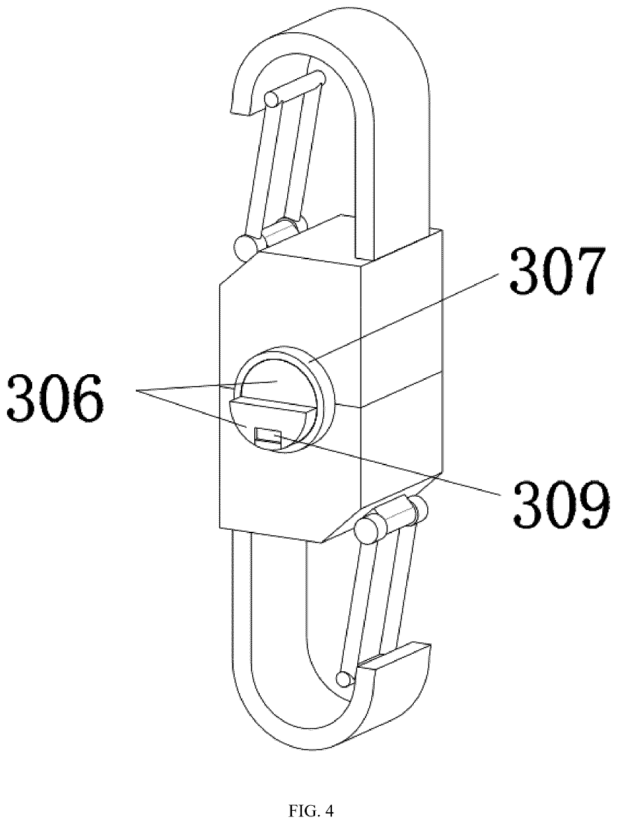

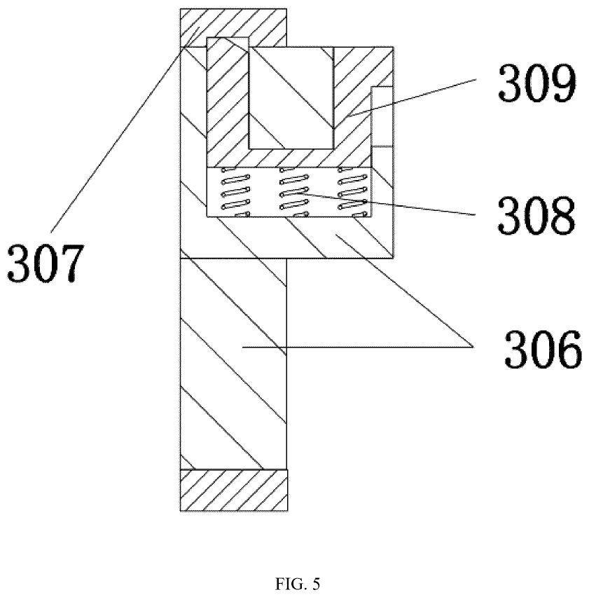

As shown in FIGS. 1-5, the present invention provides a technical solution: a double ended hook with dual locks, comprising a hook frame 1, the hook frame 1 is provided with a locking member 2, the bottom end of the hook frame 1 is fixedly connected with a magnetic block 4, one side of the hook frame 1 is fixedly connected with a reinforcement lock member 3 for connecting with another hook frame 1.

The reinforcement lock member 3 comprises a first locking buckle 301, one end of the first locking buckle 301 is rotatably connected with one side of the hook frame 1, the other side of the hook frame 1 is fixedly connected with a first limiting member 302, and the bottom end of the first limiting member 302 is provided with a first limiting groove.

The reinforcement lock member 3 further comprises a rotating member 303, one end of the rotating member 303 is rotatably connected to one side of the hook frame 1, the inner wall of the rotating member 303 is rotatably connected to a second locking buckle 304, and one side of the other hook frame 1 is fixedly connected to a second limiting member 305, and the top of the second limiting member 305 is provided with a second limiting groove.

The reinforcement lock member 3 further comprises a half disk 306 fixedly installed on one side of the hook frame 1, and the outer wall of the half disk 306 is slidably connected with a circular ring 307, and a restriction member that restricts the movement of circular ring 307 is installed on the half disk 306.

The limiting member comprises a micro spring 308 fixedly installed inside the half disk 306, one end of the micro spring 308 is fixedly connected to the third limiting member 309, and a limiting groove is provided inside the circular ring 307 for contacting the third limiting member 309, and the outer wall of the third limiting member 309 is slidably connected to the interior of the half disk 306.

The interior of the half disk 306 is provided with a sliding groove, and the outer wall of the third limiting member 309 is slidably connected to the interior of the half disk 306 through the sliding groove.

The locking member 2 comprises a limiting rotating rod 201, the bottom end of the limiting rotating rod 201 is rotatably connected to the hook frame 1, and a torsion spring is fixedly connected at the rotational connection between the limiting rotating rod 201 and the hook frame 1.

Two hook frames 1 are respectively adsorbed by magnetic blocks 4, and a reinforcement lock member 3 is used to reinforce the connection between the two hook frames 1, reducing the separation between the two hook frames 1 due to excessive force or direction of force and, when the hook frame 1 is being used, the limiting rotating rod 201 can be rotated to be away from the hook frame 1, and the torsion spring is subjected to torsional force, so that the item is inside the hook frame 1 and afterwards, the limiting rotating rod 201 and hook frame 1 will come into contact again under the action of torsion spring.

In Embodiment 1, when the first locking buckle 301 is rotated, the rotating first locking buckle 301, due to the elasticity of the first limiting member 302 itself, applies force to the first limiting member 302, so that the first locking buckle 301 comes into contact with the inner wall of the first limiting groove.

In Embodiment 2, the rotation center line between the rotating member 303 and the hook frame 1 cannot be in a straight line with that between the second locking buckle 304 and the rotating member 303, and when the rotating member 303 rotates, the second locking buckle 304 also rotates, the second limiting member 305 does not need to have elasticity, the rotating member 303 and second locking buckle 304 rotate simultaneously, so that the second locking buckle 304 comes into contact with the inner wall of second limiting groove, then the rotating member 303 rotates in the opposite direction, thereby fixing the reinforcement lock member 3 and reinforcing the fixation between the two hook frames 1.

In Embodiment 3, the circular ring 307 is moved so that the outer wall of upper half disk 306 of the other hook frame 1 comes into contact with the inner wall of the circular ring 307, then the circular ring 307 is limited in its current position by a limiting member and in order to make the two hook frames 1 adsorb through magnetic block 4, the upper half disk 306 of the two hook frames 1 may have different thickness, a limiting member is installed on the half disk 306 having a thickness greater than that of the other half disk 306; the third limiting member 309 keeps the circular ring 307 in fixed position under the pressure of micro spring 308, and when it is necessary to cancel the installation, the third limiting member 309 should be pressed to compress the micro spring 308, causing the limiting member away from the limiting groove, then the circular ring 307 can be moved to separate the two hook frames 1, and during the use of hook frame 1, the use of limiting member will not be affected because the main force is exerted on magnetic block 4 and circular ring 307.

The deployment of reinforcement lock member 3 can further fix the position between two hook frames 1 under magnetic adsorption, so that even when the double ended hook is loading a weight exceeding the adsorption force between the magnetic blocks 4, the reinforcing lock member 3 will bear the load capacity between the two hook frames 1, thereby minimizing the separation of double ended hooks during use, and the simple operation of the reinforcing lock member 3 improves the convenience of the double ended hook; At the same time, the deployment of limiting member can further restrict the movement of circular ring 307 during use, so that the circular ring 307 is fixed in the set position and during use, the load-bearing force acts on the magnetic block 44 and the circular ring 307, while the limiting member is not subjected to external forces, thus ensuring the limitation of the circular ring 307, and this design improves the practicality of limiting member and the reliability of the double ended hook.

Although the embodiments of the present invention have been presented and described, it will be understood by those skilled in the art that various changes, modifications, substitutions, and variations can be made to these embodiments without departing from the principles and spirit of the present invention. The scope of the present invention is limited by the accompanying embodiments and their equivalents.

What is claimed is:

1. A double ended hook with dual locks, comprising a hook frame (1), wherein the hook frame (1) is provided with a locking member (2), the bottom end of the hook frame (1) is fixedly connected with a magnetic block (4), one side of the hook frame (1) is fixedly connected with a reinforcement lock member (3) for connecting with another hook frame (1);
the reinforcement lock member (3) comprises a first locking buckle (301), one end of the first locking buckle (301) is rotatably connected with one side of the hook frame (1), and the other side of the hook frame (1) is fixedly connected with a first limiting member (302), and the bottom end of the first limiting member (302) is provided with a first limiting groove.

2. The double ended hook with dual locks according to claim 1, wherein the reinforcement lock member (3) further comprises a rotating member (303), one end of the rotating member (303) is rotatably connected to one side of the hook frame (1), the inner wall of the rotating member (303) is rotatably connected to a second locking buckle (304), and one side of the other hook frame (1) is fixedly connected to a second limiting member (305), and the top of the second limiting member (305) is provided with a second limiting groove.

3. The double ended hook with dual locks according to claim 1, wherein the reinforcement lock member (3) further comprises a half disk (306) fixedly installed on one side of the hook frame (1), and the outer wall of the half disk (306) is slidably connected with a circular ring (307), and a restriction member that restricts the movement of circular ring (307) is installed on the half disk (306).

4. The double ended hook with dual locks according to claim 3, wherein the limiting member comprises a micro spring (308) fixedly installed inside the half disk (306), one end of the micro spring (308) is fixedly connected to the third limiting member (309), and a limiting groove is provided inside the circular ring (307) for contacting the third limiting member (309), and the outer wall of the third limiting member (309) is slidably connected to the interior of the half disk (306).

5. The double ended hook with dual locks according to claim 4, wherein the interior of the half disk (306) is provided with a sliding groove, and the outer wall of the third limiting member (309) is slidably connected to the interior of the half disk (306) through the sliding groove.

6. The double ended hook with dual locks according to claim 1, wherein the locking member (2) comprises a limiting rotating rod (201), the bottom end of the limiting rotating rod (201) is rotatably connected to the hook frame (1), and a torsion spring is fixedly connected at the rotational connection between the limiting rotating rod (201) and the hook frame (1).
